(19) United States
(12) Patent Application Publication
(10) Pub. No.: US 2007/0019127 A1
(43) Pub. Date: Jan. 25, 2007

(54) Liquid crystal display device

(75) Inventor: Eiji Oohira, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/451,564

(22) Filed: Jun. 13, 2006

(30) Foreign Application Priority Data
Jul. 20, 2005 (JP) 2005-210194

(51) Int. Cl. G02F 1/1333

(52) U.S. Cl. 349/58

(57) ABSTRACT

The present invention aims at the miniaturization and the reduction of thickness of a liquid crystal display device. In a liquid crystal display device which includes: a liquid crystal display panel; a backlight which is arranged on a back side of the liquid crystal display panel; and a flexible printed wiring board which has one end thereof connected to a terminal portion of the liquid crystal display panel, the backlight includes a frame-like mold and a reflection sheet, the reflection sheet is adhered to a back side of the frame-like mold, the flexible printed wiring board is folded and has a portion thereof arranged on back sides of the frame-like mold and the reflection sheet, and the flexible printed wiring board is adhered to the back side surface of the frame-like mold at a position where the flexible printed wiring board is not overlapped to the reflection sheet as viewed in a plan view.

The present application claims priority from Japanese application JP2005-210194 filed on Jul. 20, 2005, the content of which is hereby incorporated by reference into this application.

### BACKGROUND OF THE INVENTION

The present invention relates to a liquid crystal display device, and more particularly to a technique which is effectively applicable to a backlight which accommodates a light guide plate, an optical sheet group and the like or a technique which is effectively applicable to a flexible printed wiring board.

A liquid crystal display module of a TFT (thin film transistor) system having a miniaturized liquid crystal display panel with the number of sub pixels of approximately 240×320×3 in color display has been popularly used as a display part of a portable equipment such as a mobile phone.

In general, a liquid crystal display module includes a liquid crystal display panel and a backlight which radiates light to the liquid crystal display panel. With respect to the liquid crystal display module which is used as a display part of a portable equipment such as a mobile phone, the backlight is constituted of a resin mold frame (hereinafter referred to as mold), an optical sheet group and a light guide plate which are arranged in the inside of the mold, and a reflection sheet which is arranged below the light guide plate.

Recently, in the liquid crystal display module for mobile phone, to satisfy a demand for the reduction of thickness of the liquid crystal display module, the structure which eliminates a bottom surface of the mold has been a main stream.

FIG. 7 to FIG. 9 show cross-sectional views of essential parts showing the conventional structures of the liquid crystal display module. In these drawing, numeral 1 indicates mold, numeral 2 indicates optical sheet group (a lower diffusion sheet, two lens sheets, a upper diffusion sheet), numeral 3 indicates a light guide plate, numeral 4 indicates a reflection sheet, numerals 5, 6 indicate glass substrates, numerals 7, 8 indicate polarizers and numerals 9, 10 indicate pressure sensitive adhesive double coated tape.

For example, as shown in FIG. 7 to FIG. 9, the liquid crystal display panel which has the largest mass in the liquid crystal display module is fixed to the mold 1 using the pressure sensitive adhesive double coated tape 10. Further, the reflection sheet 4 is fixed to the mold 1 using the pressure sensitive adhesive double coated tape 9.

The conventional structural example shown in FIG. 7 is constituted such that out of a pair of glass substrates (5, 6) which form the liquid crystal display panel, the lower glass substrate 6 is fixed to the mold 1 by the pressure sensitive adhesive double coated tape 10, and the lower polarizer 8 is dropped into the inside of the mold 1.

The conventional structural example shown in FIG. 8 adopts a method in which the polarizer 8 arranged below the liquid crystal display panel is fixed to the mold 1 using the pressure sensitive adhesive double coated tape 10, wherein the pressure sensitive adhesive double coated tape 10 is also used for holding the optical sheet group 2 arranged in the inside of the mold 1.

The conventional structural example shown in FIG. 9 is constituted such that, in the same manner as the conventional structural example shown in FIG. 7, out of a pair of glass substrates (5, 6) which constitutes the liquid crystal display panel, the lower glass substrate 6 is fixed to the mold 1 using the pressure sensitive adhesive double coated tape 10, the lower polarizer 8 is dropped in the inside of the mold 1 and, further, the optical sheet group 2 and the like arranged in the inside of the mold 1 are sandwiched between a projecting portion 1a formed in the mold 1 and the light guide plate 3.

On the other hand, recently, in the liquid crystal display module for mobile phone, to cope with a demand for the miniaturization and the reduction of thickness, the structure which allows a flexible printed wiring board (hereinafter referred to as FPC) which supplies a power source, control signals and the like from the outside for driving the liquid crystal display panel to wrap a back side of the backlight and fixes the FPC to the back side has been increasing in number. Various electronic parts are mounted on the FPC 11.

Here, among the mounting electronic parts of the FPC 11, a semi-fixed resistance element for Vcom adjustment which adjusts the setting of the reference voltage (or a center electrode voltage) (hereinafter referred to as Vcom) of the liquid crystal display panel is included.

This semi-fixed resistance element for Vcom adjustment is, for example, as shown in FIG. 10, installed at a position where the setting of Vcom can be adjusted even in an assembly completion state of the liquid crystal display module.

Here, FIG. 10 shows the conventional structure of the liquid crystal display module which arranges the semi-fixed resistance element for Vcom adjustment therein. In FIG. 10, numeral 11 indicates a FPC (flexible printed wiring board), numerals 12, 13 indicate semiconductor chips which constitute drive circuits, and numeral 14 indicates a semi-fixed resistance element for Vcom adjustment.

The conventional structural example shown in FIG. 10 is an example in which the semi-fixed resistance element 14 for Vcom adjustment is arranged outside the mold 1.

Further, in the structure which allows the FPC 11 to wrap around the back surface from a terminal portion of the liquid crystal display panel with a minimum radius, the FPC 11 has a strong spring-back and hence, the FPC 11 is held by a method shown in FIG. 11 or FIG. 12, for example.

Here, in FIG. 11 and FIG. 12 are views showing the conventional structures for pulling the FPC 11 around the back side of the backlight and fixing the FPC 11 to the back side in the liquid crystal display module.

The conventional structural example shown in FIG. 11 adopts a method in which the FPC 11 is engaged with and held by a hook 21 which is mounted on a bottom surface portion of the mold 1.

The conventional structural example shown in FIG. 12 adopts a method in which a projecting rib 22 is mounted on a side surface of the mold 1 and the FPC 11 is engaged with and fixed by the rib 22.

### SUMMARY OF THE INVENTION

The above-mentioned conventional structural example shown in FIG. 7 has a drawback that a size of the light guide plate 3 is larger than a size of the light guide plate in the conventional structural example shown in FIG. 8 thus exhibiting the low light emitting luminance per unit area. In the conventional structural example shown in FIG. 7, in an attempt to reduce the size of the light guide plate 3, the clearance between the mold 1 and the light guide plate 3 is increased thus giving rise to a possibility that a play is formed or the light guide plate is dropped from the mold 1.

Further, the conventional structural example shown in FIG. 8 is configured such that the lower polarizer 8 of the liquid crystal display panel is adhered to the mold 1 using the pressure sensitive adhesive double coated tape 10 and hence, between the lower polarizer 8 and the optical sheet group 2, the clearance substantially equal to a thickness of the pressure sensitive adhesive double coated tape 10 is generated (the total thickness of the clearance being increased) whereby the conventional structural example shown in FIG. 8 is the structure which is inferior to the reduction of the thickness of the liquid crystal display module for mobile phone.

Further, this structure also has a drawback that an adhesive strength between the lower polarizer 8 and the mold 1 is not sufficient and hence, there exists a possibility that the liquid crystal display panel floats.

In the conventional structural example shown in FIG. 9, a size of the light guide plate 3 is large and hence, this conventional structural example is further inferior to the conventional structural example shown in FIG. 7 with respect to the light emitting luminance. Further, the thickness of the liquid crystal display module is increased due to the projecting portion la formed on the mold 1 and hence, the structure shown in FIG. 9 is further inferior to the conventional structural example shown in FIG. 8 with respect to the reduction of the thickness.

Here, the realization of the structure in which the FPC 11 which supplies the power source, control signals and the like which drive the liquid crystal display panel from the outside wraps around the back side of the backlight and is arranged on the back side of the reflection sheet 4 and the FPC 11 alone is fixed to the backlight may be considered. In this case, in the conventional structural example shown in FIG. 7 and FIG. 9, it is difficult to ensure a tape region to which the FPC 11 is fixed. Further, in the conventional structural example shown in FIG. 8, although it is possible to ensure a tape region to which the FPC 11 is fixed, it is impossible to realize an adhesive strength between the liquid crystal display panel and the mold which is capable of withstanding a bending repulsive force (spring-back force) of the FPC 11 which is folded back to the back surface of the backlight.

Further, in the conventional structural example shown in FIG. 10, the semi-fixed resistance element 14 for Vcom adjustment is arranged outside the mold 1 and hence, it is difficult to realize the miniaturization of the liquid crystal display module for mobile phone. Further, when there exists a demand that conductive parts made of metal or the like should not be projected from the periphery of the mold 1 or a demand that the mold 1 should not be configured to form an obstacle in holding the mold 1 from the periphery thereof, there arises a drawback that the conventional structural example shown in FIG. 10 can not be adopted.

Further, the conventional structural example shown in FIG. 11 has a drawback that it is necessary to form a recessed portion or a through hole for avoiding the hook 21 of the mold 1 in a part which is brought into contact with a lower surface of the backlight and hence, a total thickness of the whole device of the mobile phone is increased. Further, when the mold 1 of the backlight is configured such that the mold 1 has no bottom surface, there may be a case that the hook 21 can not be installed.

Further, the conventional structural example shown in FIG. 12 cannot be adopted when the installation of the rib 22 is impossible due to the restriction such as required profile sizes. Further, since the FPC 11 is held on the side surface of the mold 1, there also arises a drawback that a center portion of the FPC 11 is bulged.

In this manner, the above-mentioned respective conventional structural examples have the drawbacks that the miniaturization and the reduction of the thickness of the liquid crystal display module for mobile phone are difficult.

The present invention has been made to overcome the drawbacks of the related art and it is an object of the present invention to provide a technique which can realize the miniaturization and the reduction of the thickness of a liquid crystal display device.

The above-mentioned and other objects and novel features of the present invention will become apparent from the description of this specification and attached drawings.

To briefly explain the summary of typical inventions among the inventions disclosed in this specification, they are as follows.

(1) In a liquid crystal display device which includes a liquid crystal display panel, a backlight which is arranged on a back side of the liquid crystal display panel, and a flexible printed wiring board which has one end thereof connected to a terminal portion of the liquid crystal display panel,

the backlight includes a frame-like mold and a reflection sheet,

the reflection sheet is adhered to a back side of the frame-like mold,

the flexible printed wiring board is folded and has a portion thereof arranged on back sides of the frame-like mold and the reflection sheet, and

the flexible printed wiring board is adhered to the back side surface of the frame-like mold at a position where the flexible printed wiring board is not overlapped to the reflection sheet as viewed in a plan view.

(2) The present invention is, in the above-mentioned constitution (1), characterized in that the flexible printed wiring board is adhered to the surface of the back side of the frame-like mold using a pressure sensitive adhesive double coated tape.

(3) The present invention is, in the constitution (1) or (2), characterized in that the flexible printed wiring board is adhered to the frame-like mold in a region outside the reflection sheet as viewed in a plan view.

(4) The present invention is, in the constitution (1) or (2), characterized in that the reflection sheet has a cutout portion which exposes the surface of the back side of the mold in a portion of a region there of which is covered with the flexible printed wiring board, and the flexible printed wiring board is adhered to the frame-like mold in the cutout portion.

(5) The present invention is, in the constitution (4), characterized in that, in the liquid crystal display device, assuming a side of the flexible printed wiring board which is folded to the back side of the frame-like mold and the reflection sheet as a folding side, in a periphery of the cutout portion and a region which is arranged closer to the folding side than the cutout portion, a region where the reflection sheet is adhered to the frame-like mold is not formed, and the reflection sheet is covered with the flexible printed wiring board.

(6) The present invention is, in any one of the constitutions (1) to (4), characterized in that, in the liquid crystal display device, assuming a side of the flexible printed wiring board which is folded to the back side of the frame-like mold and the reflection sheet as a folding side,

in a region along a long side of the reflection sheet which is within a distance from the folding side larger than a distance “d”, a region where the reflection sheet is adhered to the frame-like mold is formed, and

in a region along the long side of the reflection sheet which is within the distance from the folding side smaller than the distance “d”, the region where the reflection sheet is adhered to the frame-like mold is not formed, and the reflection sheet is covered with the flexible printed wiring board.

(7) The present invention is, in any one of the constitutions (1) to (6), characterized in that, a region where the flexible printed wiring board is adhered to the surface of the back side of the frame-like mold has a shape in which a size in the direction perpendicular to the side along which the flexible printed wiring board is folded to the back side of the frame-like mold and the reflection sheet is longer than a size in the direction parallel to the side along which the flexible printed wiring board is folded to the back side of the frame-like mold and the reflection sheet.

(8) The present invention is, in any one of the constitutions (1) to (7), characterized in that the frame-like mold includes a projecting portion on the back side thereof, and

the flexible printed wiring board has a through hole into which the projecting portion is inserted at a portion thereof corresponding to the projecting portion.

(9) The present invention is, in any one of the constitutions (1) to (8), characterized in that the backlight includes at least one optical sheet which is arranged in the inside of the frame-like mold and a light guide plate which is arranged in the inside of the frame-like mold,

at least one side of the frame-like mold includes first to third portions where a distance between one side and an opposing side is changed in a stepped manner,

the distance between one side and the opposing side in the second portion is narrower than the distance between one side and the opposing side in the first portion,

the distance between one side and the opposing side in the third portion is narrower than the distance between one side and the opposing side in the second portion,

one substrate of the liquid crystal display panel is fixed to a first stepped portion which is formed by the first portion and the second portion,

at least one optical sheet is supported on a second stepped portion which is formed by the second portion and the third portion, and

the light guide plate is arranged inside the third portion.

(10) The present invention is, in the constitution (9), characterized in that the at least one optical sheet supported on the second stepped portion is constituted of two or more optical sheets.

(11) The present invention is, in the constitution (9) or (10), characterized in that the liquid crystal display panel includes at least one optical sheet which is arranged inside the third portion.

(12) The present invention is, in the constitution (9) or (10), characterized in that the optical sheet is not arranged inside the third portion.

(13) The present invention is, in any one of the constitutions (9) to (12), characterized in that a frame width of the frame-like mold is changed in a stepped manner in the first to third portions,

the frame width of the frame-like mold is larger in the second portion than in the first portion, and

the frame width of the frame-like mold is larger in the third portion than in the second portion.

(14) The present invention is, in any one of the constitutions (9) to (13), characterized in that a side of the frame-like mold on which the first to third portions are formed is a long side of the frame-like mold.

(15) The present invention is, in any one of the constitutions (9) to (14), characterized in that one substrate of the liquid crystal display panel has a polarizer which faces the at least one optical sheet, and

the polarizer has an end portion thereof overlapped to the second stepped portion as viewed in a plan view.

(16) A liquid crystal display device which includes a backlight, a liquid crystal display panel which is arranged over the backlight, and a flexible printed wiring board has one end thereof connected to a terminal portion of the liquid crystal display panel, wherein

the flexible printed wiring board includes an electronic part whose setting is adjustable and a through hole,

the flexible printed wiring board is folded and has a portion thereof arranged on a back side of the backlight, and

the electronic part whose setting is adjustable is arranged at a position deeper than the through hole and at a position where the electronic part is overlapped to the through hole in a state that the liquid crystal display device is viewed from a liquid crystal display panel side.

(17) The present invention is, in the constitution (16), characterized in that the backlight includes a frame-like mold, and

the electronic part whose setting is adjustable is arranged inside a profile of the frame-like mold as viewed in a plan view.

(18) The present invention is, in any one of the constitutions (16) or (17), characterized in that the electronic part whose setting is adjustable is a semi-fixed resistance element or a variable resistance element.

(19) The present invention is, in any one of the constitutions (16) to (18), characterized in that the electronic part whose setting is adjustable is an electronic part which adjusts a counter electrode voltage of the liquid crystal display panel.

Here, in the present invention, the constitutions (1) to (8), the constitutions (9) to (15), and the constitutions (16) to (19) may be applied in a single form or in combination by combining these constitutions.

Further, the constitutions (1) to (19) merely constitute one example and various modifications can be made without departing from the technical concept of the present invention.

To briefly explain advantageous effects obtained by the typical inventions among the inventions disclosed in this specification, they are as follows.

That is, according to the liquid crystal display device of the present invention, it is possible to realize the miniaturization and the reduction of thickness of the liquid crystal display device.

### BRIEF DESCRIPTION OF THE DRAWINGS

FIG. 1A and FIG. 1B are views showing a liquid crystal display module of an embodiment of the present invention;

FIG. 2A is a view showing a state in which an FPC is developed in FIG. 1B;

FIG. 2B is a view for explaining a reflection sheet shown in FIG. 2A;

FIG. 3 is a cross-sectional view showing a cross-sectional structure taken along a line A-A′ in FIG. 1A;

FIG. 4 is a cross-sectional view showing a cross-sectional structure taken along a line B-B′ in FIG. 1A;

FIG. 5A and FIG. 5B are views for explaining a shape of a mold shown in FIG. 1A and FIG. 1B;

FIG. 6 is a cross-sectional view of an essential part showing a modification of a liquid crystal display module of the embodiment of the present invention;

FIG. 7 is a cross-sectional view of an essential part showing a conventional structure of the liquid crystal display module;

FIG. 8 is a cross-sectional view of an essential part showing a conventional structure of the liquid crystal display module;

FIG. 9 is a cross-sectional view of an essential part showing a conventional structure of the liquid crystal display module;

FIG. 10 is a view showing the conventional structure which arranges a semi-fixed resistance element for adjusting Vcom;

FIG. 11 is a view showing the conventional structure which pulls FPC around a back surface of a backlight and fixes the backlight to the back surface; and

FIG. 12 is a view showing the conventional structure which pulls FPC around a back surface of a backlight and fixes the backlight to the back surface.

### DESCRIPTION OF THE PREFERRED EMBODIMENTS

Hereinafter, an embodiment of the present invention is explained in detail in conjunction with drawings.

Here, in all drawings for explaining the embodiment, parts having identical functions are given the same symbols and their repeated explanation is omitted.

A liquid crystal display module of the embodiment of the present invention is a TFT-system liquid crystal display module having a miniaturized liquid crystal panel of approximately 240×320×3 in color display and is used as a display part of a portable equipment such as a mobile phone.

The liquid crystal display module of this embodiment is constituted of a backlight and a liquid crystal display panel which is arranged over the backlight.

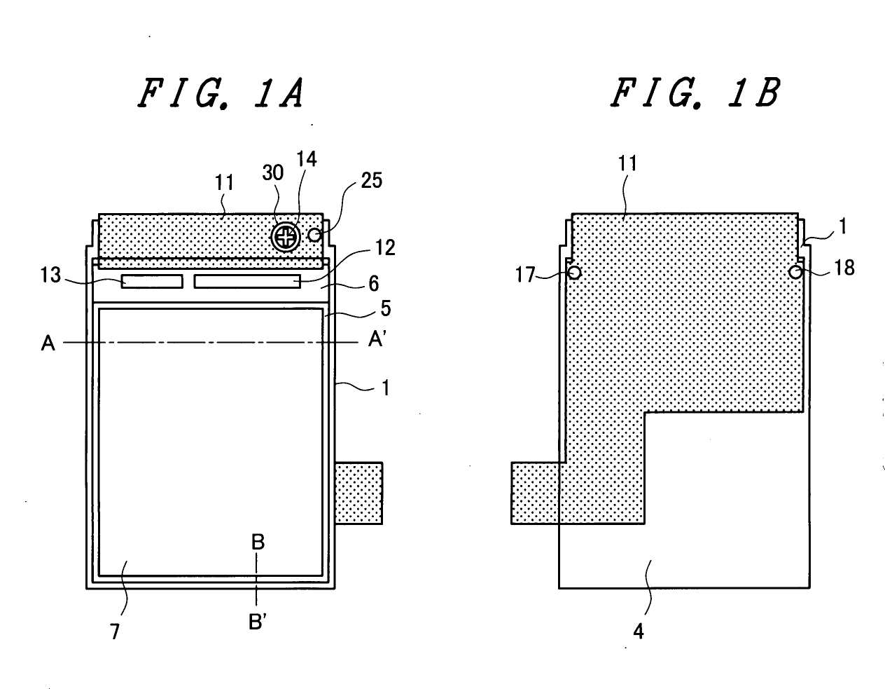

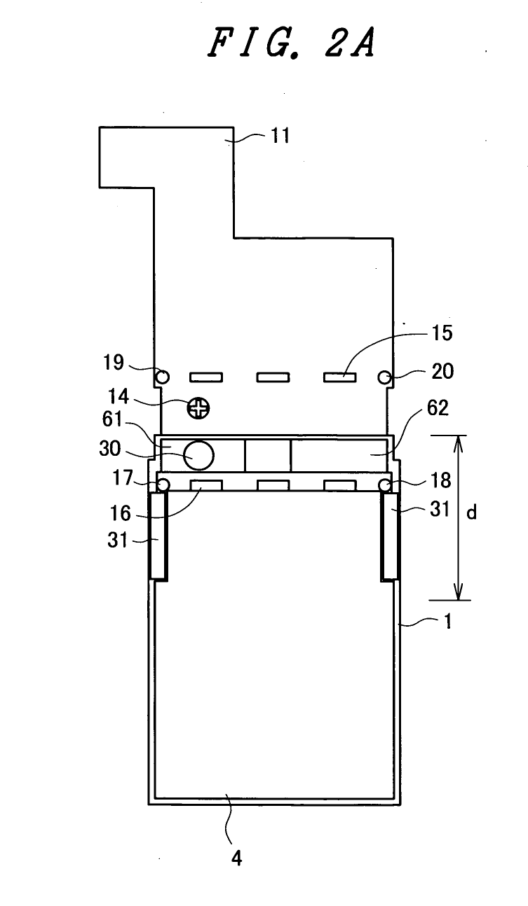

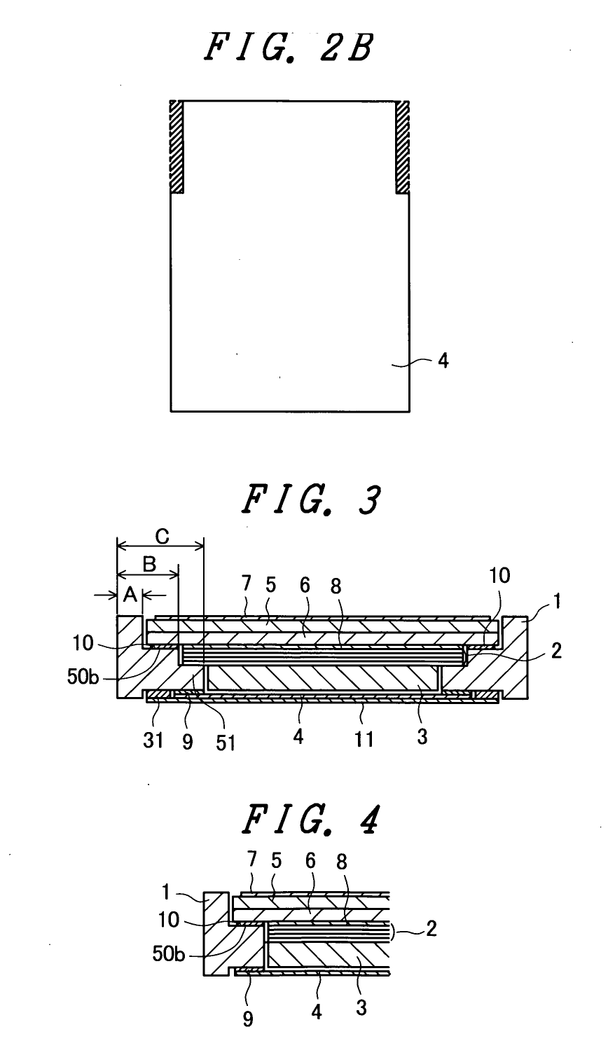

FIG. 1A and FIG. 1B are views showing the liquid crystal display module of this embodiment, wherein FIG. 1A is a view as viewed from an upper side (liquid crystal display panel side, front face side, viewer's side), and FIG. 1B is a view as viewed from a lower side (light guide plate side, backside, rear side). Further, FIG. 2A is a view showing a state in which a FPC 11 is developed in FIG. 1B.

In these drawing, numeral 1 indicates a mold (resin mold frame), numeral 4 indicates a reflection sheet, numerals 5, 6 indicate glass substrates, numeral 7 indicates an upper polarizer, numeral 11 indicates the FPC (flexible printed wiring board), numerals 12, 13 indicate semiconductor chips which constitute drive circuits, numeral 14 indicates a semi-fixed resistance element for adjusting Vcom, numeral 15 indicates a white light-emitting diode (light source), numeral 16 indicates a recessed portion in which the white light emitting diode 15 is accommodated, numerals 17, 18, 25 indicate projecting portions, numeral 30 indicates a through hole, numeral 31 indicates a pressure sensitive adhesive double coated tape (adhering member).

The liquid crystal display panel is constituted as follows. The glass substrate on which pixel electrodes, thin film transistors and the like are formed (also referred to as TFT substrate) 6 and the glass substrate on which color filters and the like are formed (also referred to as counter substrate) 5 are overlapped to each other with a predetermined gap therebetween. Both substrates are adhered to each other by a frame-like sealing material which is formed between both substrates and in the vicinity of peripheral portions of both substrates and, at the same time, liquid crystal is filled and sealed in the inside of the sealing material between both substrates from a liquid crystal sealing port formed in a portion of the sealing material. Further, polarizers (7, 8) are adhered to outsides of both substrates.

In this manner, the liquid crystal display module adopts the structure in which the liquid crystal is sandwiched between a pair of substrates. Here, a material of the substrates may be any material which can form an insulating substrate. That is, the material of the substrates is not limited to glass and may be plastic or the like. Further, the color filters may be formed on the TFT substrate side in place of the counter substrate side. In a monochroic liquid crystal display panel, color filters are unnecessary. In a liquid crystal display device which adopts field sequential system, color filters are not formed and a three-color light source may be used in place of a white light emitting diode.

A counter electrode may be formed on the counter substrate side when the liquid crystal display panel is a liquid crystal display panel which adopts a TN system or a VA system. When the liquid crystal display panel adopts an IPS system, the counter electrode is formed on the TFT substrate side.

Here, the present invention is irrelevant to the inner structure of the liquid crystal panel and hence, the detail of the inner structure of the liquid crystal panel is omitted. Further, the present invention is applicable to the liquid crystal panel having any structure.

FIG. 3 is a cross-sectional view showing the cross-sectional structure taken along a line A-A′ in FIG. 1A, and FIG. 4 is a cross-sectional view showing the cross-sectional structure taken along a line B-B′ in FIG. 1A.

In these drawings, numeral 2 indicates an optical sheet group (lower diffusion sheet, two lens sheets, upper diffusion sheet), and numeral 3 indicates a light guide plate.

The backlight of this embodiment includes the optical sheet group 2 which is constituted of the lower diffusion sheet, the two lens sheets and the upper diffusion sheet, a light guide plate 3, a reflection sheet 4 which is arranged below the light guide plate 3, and the white light emitting diode 15 which is arranged on a side surface of the light guide plate 3. The backlight of this embodiment is constituted by arranging the optical sheet group 2, the light guide plate 3 and the reflection sheet 4 in the inside of the mold 1 in order shown in FIG. 3 and FIG. 4.

Here, the optical sheet group 2 is not limited to the four-sheet constitution of this embodiment. For example, the present invention may adopt the constitution which uses only one diffusion sheet instead of using two diffusion sheets. Further, the present invention may use only one lens sheet (prism sheet) instead of using two lens sheets. Further, by allowing the light guide plate 3 to perform also a function of the lens sheet by forming grooves in the light guide plate 3, it is possible to eliminate the lens sheet. Accordingly, the optical sheet group 2 may be formed of one optical sheet. Further, it may be possible to use the optical sheets other than the diffusion sheet and the lens sheet. As can be understood from above, the optical sheet group 2 may be replaced with at least one optical sheet.

Further, the white light emitting diode 15 is mounted on the FPC 11 and is arranged in the inside of the recessed portion 16 formed on a side surface of the light guide plate 3. Here, the reflection sheet 4 is adhered (or stack) or fixed to the mold using the pressure sensitive adhesive double coated tape (adhering member) 9.

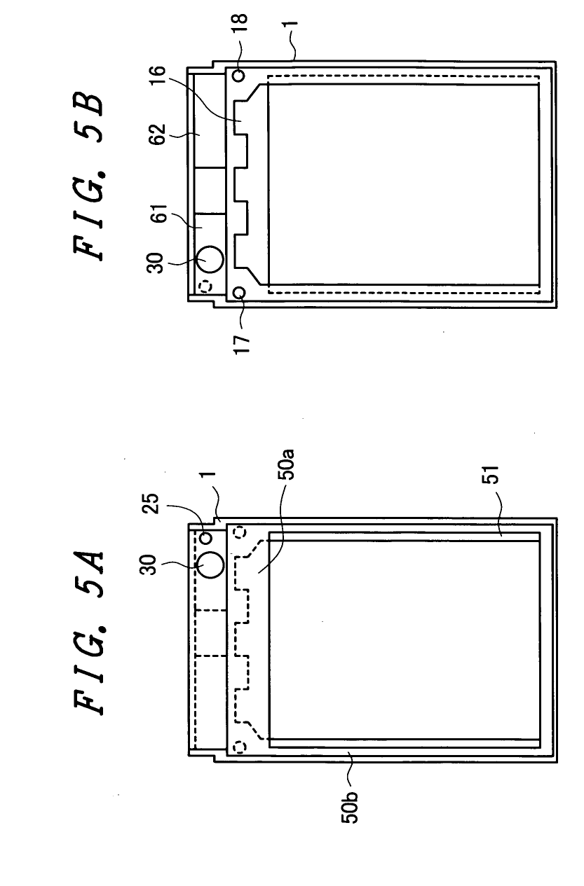

FIG. 5A and FIG. 5B are views for explaining a shape of the mold shown in FIG. 1A and FIG. 1B, wherein FIG. 5A is a view which views the mold shown in FIG. 1A from above (liquid crystal display panel side) and FIG. 5B is a view which views the mold shown in FIG. 1B from a lower side (light guide plate side).

As shown in FIG. 5A and FIG. 5B, the mold 1 of this embodiments adopts the structure in which a bottom surface is cut off and an opening portion is formed in a center portion thereof, that is, a frame-like body (or cylindrical body) having an approximately quadrangular cross-sectional shape. Accordingly, the reflection sheet 4 is adhered to a back side of the frame-like mold 1.

As shown in FIG. 3, FIG. 5A, FIG. 5B, in this embodiment, a size of the light guide plate 3 is set equal to a size of the conventional structure (a necessary minimum size, for example, a size which is obtained by adding a necessary minimum region to a size of a pixel region of the liquid crystal display panel by taking irregularities of mating displacement or the like into consideration or a size which ensures a minimum region necessary for performing injection molding).

Accordingly, this embodiment adopts the structure which allows a frame width of the mold 1 around the light guide plate 3 to approach the light guide plate by increasing a thickness of a wall of the mold 1 or the like. That is, in this embodiment, two sides of the mold 1 (preferably long sides of the mold 1) (sides perpendicular to an incident surface of the light guide plate 3) include a first to third portions which change a distance between the side and an opposing side in a step-like manner. Here, the distance between the second portion (the portion indicated by B in FIG. 3) and the opposing side is set smaller than the distance between the first portion (the portion indicated by A in FIG. 3) and the opposing side and, while the distance between the third portion (the portion indicated by C in FIG. 3) and the opposing side is set smaller than the distance between the second portion and the opposing side.

Further, a first stepped portion (50b) is formed of the first portion A and the second portion B.

The liquid crystal display panel has a peripheral portion of the lower glass substrate 6 supported and fixed to the stepped portion 50b of the mold 1 by the pressure sensitive adhesive double coated tape (adhering member) 10.

Further, a second stepped portion 51 is formed of the second portion B and the third portion C and the optical sheet group 2 is supported on the stepped portion 51.

Further, the light guide plate 3 is arranged inside the third portion C.

The reflection sheet 4 is arranged below the light guide plate 3 so as to cover an opening portion of the mold 1.

Further, in this embodiment, an end portion of the lower polarizer 8 is positioned in the inside of the second stepped portion 51. That is, as viewed in a plan view, the end portion of the lower polarizer 8 is configured to be overlapped to the second stepped portion 51. Due to such a constitution, it is possible to eliminate the drawback attributed to the thickness of the polarizer 8 explained in conjunction with FIG. 8.

Here, in this embodiment, as a method which approaches the inner wall of the mold 1 to the light guide plate 3, either the method which partially increases the wall thickness of the mold 1 or a method which moves a wall position to the inside while maintaining the same frame width may be adopted.

From a viewpoint of durability, as shown in FIG. 3, it is preferable that the second portion B exhibits the larger frame width of the frame-like mold 1 than the first portion A, and the third portion C exhibits the larger frame width of the frame-like mold 1 than the second portion B.

In this manner, according to this embodiment, it is possible to enhance the brightness compared to the conventional structure while realizing the reduction of thickness of the liquid crystal display module.

Here, in this embodiment, the optical sheet group 2 which is supported on the stepped portion 51 may be formed of at least one optical sheet.

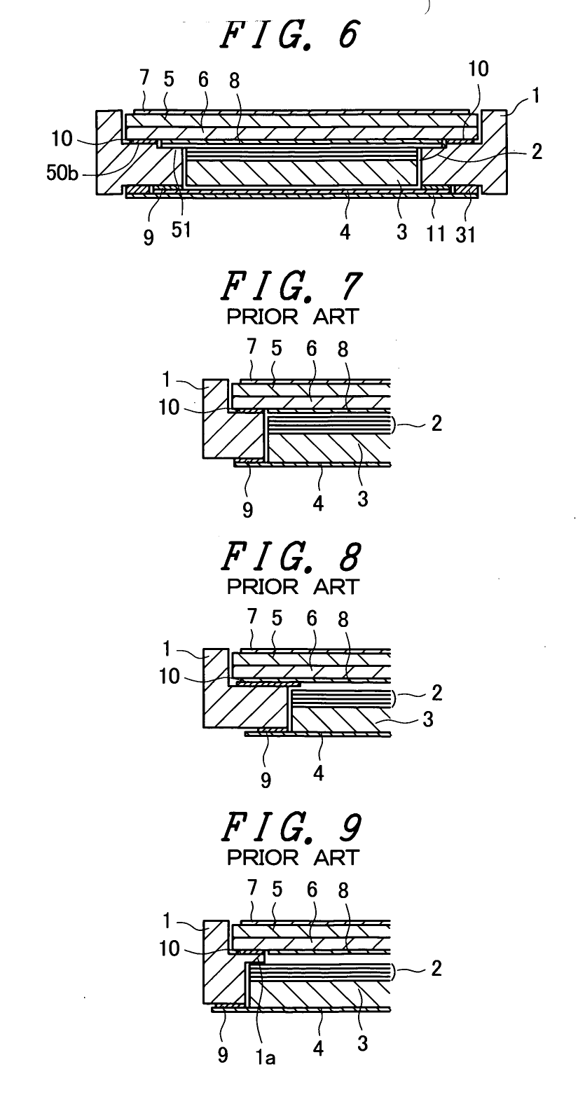

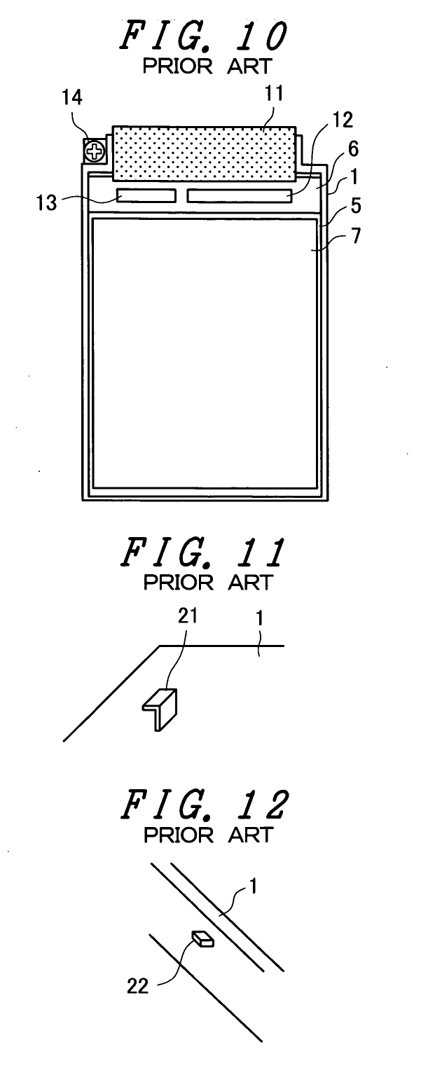

FIG. 6 is a cross-sectional view of an essential part showing a modification of the liquid crystal display module of the embodiment of the present invention.

For example, as shown in FIG. 6, the upper diffusion sheet among the optical sheet group 2 is supported on the stepped portion 51, and other optical sheets (two lens sheets, the lower diffusion sheet) may be arranged on the light guide plate 3 inside the third portion.

Here, as shown in FIG. 6, the upper diffusion sheet among the optical sheet group 2 is supported on the stepped portion 51 for preventing the intrusion of dusts into the inside of the third portion C.

Here, the constitution of the optical sheet group 2 is not limited to the above-mentioned constitution. That is, it is sufficient that at least one optical sheet is arranged on the stepped portion 51 and the number of optical sheets which are arranged inside the third portion C is not particularly limited.

While the embodiments explained in conjunction with FIG. 3 and FIG. 6 describe the structure related to the long sides of the frame-like mold, the third portion C may not be formed on the short side of the mold 1 as shown in FIG. 4, FIG. 5A and FIG. 5B. Here, out of the short side of the mold 1, on the side where the white light emitting diode 15 is arranged, the stepped portion 50a is formed in the same manner as the stepped portion 50b. The stepped portion 50a is set to have the larger width than the stepped portion 50b and the white light emitting diode 15 is accommodated in a rear side of the stepped portion 50a.

Also in this embodiment, the FPC 11 wraps around (by folding) a back side of a backlight and is fixed to the back side. Here, in pulling the FPC 11 around the back surface of the backlight and fixing the FPC 11 to the back side, at least some of electronic parts which are mounted on the FPC 11 may be accommodated in the mold 1.

That is, as shown in FIG. 5B, recessed portions (61, 62) which have lower sides (back sides) thereof opened are formed in the mold 1, and at least some of the electronic parts which are mounted on the FPC 11 may be accommodated in these recessed portions (61, 62). Here, although FIG. 5B shows the case in which the recessed portions (61, 62) having bottom portions constitute electronic parts accommodating portions, the bottom portions are not indispensable in constitution and hence, a frame-like portion having no bottom portion (through hole) may be also used as the electronic parts accommodating portion.

The electronic parts which are mounted on the FPC 11 include an electronic part whose setting is adjustable (for example, a semi-fixed resistance element 14 for Vcom adjustment which serves to adjust the setting of a reference voltage (or a counter electrode voltage) Vcom of the liquid crystal display panel)

In this embodiment, in pulling the FPC 11 around the back side of the backlight and fixing the FPC 11 to the back side, a through hole 30 is formed in the FPC 11 at a position above the semi-fixed resistance element for Vcom adjustment. When the electronic parts accommodating portion of the mold 1 includes the bottom portion, the through hole 30 is also formed in the mold 1. Here, when the electronic parts accommodating portion of the mold 1 is formed in a frame shape having no bottom portion, the electronic parts accommodating portion per se plays a role of the through hole. Accordingly, as shown in FIG. 1A, when the liquid crystal display device is viewed from the liquid crystal display panel side, the electronic part whose setting is adjustable (the semi-fixed resistance element for Vcom adjustment 14) is arranged at a position deeper than the through hole 30 formed in the FPC 11 and, at the same time, at a position where the electronic part is overlapped to the through hole 30. Accordingly, even in an assembly completion state of the liquid crystal display module, the semi-fixed resistance element for Vcom adjustment is configured to be adjustable. Further, an operator can display an image on the display panel and can adjust the semi-fixed resistance element 14 by watching the image and hence, the liquid crystal display module also can obtain an advantage that the adjustment is facilitated. Further, since the electronic part whose setting is adjustable is positioned deeper than the through hole 30 formed in the FPC 11, there is no possibility that the electronic part projects from the front surface side thus realizing the reduction of the thickness of the liquid crystal display module.

In this embodiment, the electronic part whose setting is adjustable is arranged more inside than a profile of the frame-like mold 1 as viewed in a plan view. Accordingly, it is no more necessary to install the electronic part whose setting is adjustable (for example, the semi-fixed resistance element 14 for Vcom adjustment) outside the mold 1 and hence, it is possible to realize the miniaturization of the liquid crystal display module.

Here, although not shown in the drawing, even when the electronic part whose setting is adjustable is arranged more inside than the profile of the frame-like mold 1 as viewed in the plan view, the present invention is applicable. Also in this case, when the liquid crystal display device is viewed from the liquid crystal display panel side, the electronic part whose setting is adjustable may be arranged at a position deeper than the through hole 30 formed in the FPC 11 and, at the same time, at a position where the electronic part is overlapped to the through hole 30. Due to such a constitution, although the electronic part whose setting is adjustable may not be protected by the mold 1, the electronic part may be protected by the FPC 11. This embodiment also can obtain an advantage that an operator can perform the adjustment while watching the liquid crystal display panel and an advantage that the liquid crystal display panel can realize the reduction of thickness thereof in the same manner as the embodiment explained in conjunction with FIG. 1A.

As described above, the liquid crystal display module for a mobile phone increasingly adopts the structure in which the FPC 11 wraps around the back side of the backlight and is fixed to the back side. However, when the FPC 11 wraps around the back side of the backlight from the terminal portion of the liquid crystal display panel with a minimum radius, the FPC 11 exhibits a strong spring-back force and hence, it is necessary to carefully hold the FPC.

This embodiment focuses on regions where the reflection sheet 4 is fixed and uses such regions also for fixing the FPC 11.

FIG. 2B is a view for explaining the reflection sheet 4 shown in FIG. 2A. As shown in FIG. 2B, the reflection sheet 4 of this embodiment has cutout portions through which the back side surface of the mold 1 is exposed in some portions of regions thereof which are covered with the FPC 11 (parts indicated by shadow in FIG. 2B).

Then, as shown in FIG. 2A, to the front surface of the mold 1 which is exposed through the cutout portions, the FPC 11 is adhered and fixed by way of pressure sensitive adhesive double coated tapes (adhering members) 31.

Further, projecting portions (17, 18) are formed on the back side surface of the mold 1, while through holes (19, 20) into which these projecting portions (17, 18) are inserted are formed in the FPC 11. Due to such a constitution, it is possible to facilitate the positioning of the FPC 11.

Further, in this embodiment, by inserting the projecting portions (17, 18) into the through holes (19, 20) of the FPC 11, it is possible to reduce the spring-back force of the FPC 11.

Here, in this embodiment, as shown in FIG. 1A, a projecting portion 25 is formed on a liquid-crystal-display-panel side of the mold 1, and the projecting portion 25 is inserted into a through hole formed in the FPC thus positioning the FPC 11.

In this manner, according to this embodiment, the FPC 11 is not fixed to the reflection sheet 4 by way of a pressure sensitive adhesive double coated tape or an adhering member and hence, it is possible to reduce brightness irregularities attributed to wrinkles or the like of the reflection sheet 4 in a high temperature environment or a changing temperature environment.

Further, by arranging the pressure sensitive adhesive double coated tape 31 while avoiding the reflection sheet 4, it is possible to prevent the thickness of the pressure sensitive adhesive double coated tape 31 which adheres and fixes the FPC 11 to the mold 1 from influencing a total thickness of the liquid crystal display module. Accordingly, a tape having a strong adhesive force maybe selected as the pressure sensitive adhesive double coated tape 31 so as to prevent the center portion of the FPC 11 from being bulged.

Due to such a constitution, this embodiment can realize the miniaturization and the reduction of thickness of the liquid crystal display module for mobile phone.

In the present invention, by adhering the FPC 11 to the back side surface of the mold 1, it is possible to suppress the bulging of the FPC 11 compared to a case in which the FPC 11 is adhered to a side surface of the mold 1. Further, as shown in FIG. 2B and FIG. 3, by adhering the FPC 11 to the back-side surface of the mold 1 at a position where the FPC 11 is not overlapped to the reflection sheet 4, it is possible to reduce a thickness of the liquid crystal display module by an amount corresponding to thicknesses of the reflection sheet 4 and the pressure sensitive adhesive double coated tape 9 for adhering the reflection sheet 4. Due to such a constitution, it is possible to use a pressure sensitive adhesive double coated tape 31 for adhering the FPC 11 having a thickness larger than the thickness of the pressure sensitive adhesive double coated tape 9 for adhering the reflection sheet 4 whereby a fixing force can be increased to cope with the spring-back force of the FPC 11. Further, since the FPC 11 is not adhered to the reflection sheet 4, the constitutional so can obtain an advantage that the deformation of the reflection sheet 4 can be prevented. Here, it must be noted that only portions where the adhesion is performed (portions where the adhering member is arranged) are described heretofore and hence, the reflection sheet 4 and the FPC 11 define regions where the reflection sheet 4 and the FPC 11 are overlapped to each other.

In the liquid crystal display device, assuming a side of the FPC 11 which is folded to the back side of the mold 1 and the reflection sheet 4 as a folding side, it is favorable that regions where the FPC 11 is adhered to the back side surface of the mold 1 (regions where the pressure sensitive adhesive double coated tapes 31 are provided) have a shape in which a size in the direction perpendicular to the folding side is set larger than a size in the direction parallel to the above-mentioned folding side. That is, it is favorable that the pressure sensitive adhesive double coated tape 31 has a shape which is elongated in the extending direction of the FPC 11. This is because that the spring-back force of the FPC 11 strongly acts in the direction approaching the folding side in the portions where the pressure sensitive adhesive double coated tapes 31 are provided in FIG. 2A.

In FIG. 2A, the cut out portions are formed in the reflection sheet 4 and hence, this embodiment can obtain an advantage that it is possible to allow the pressure sensitive adhesive double coated tapes 31 to have a wide width. However, when the mold 1 has the wide frame width as explained in conjunction with FIG. 3 and FIG. 8, it is unnecessary to form the cutout portions in the reflection sheet 4. In this case, it is possible to use the reflection sheet 4 having an approximately rectangular shape.

Here, FIG. 3 illustrates the constitution in which the reflection sheet 4 is adhered to the mold 1 by the pressure sensitive adhesive double coated tape 9 also in peripheries of the cutout portions. However, the present invention is not limited to such a constitution. For example, the liquid crystal display device may be constituted as follows. That is, in peripheral portions of the cutout portions and region of the reflection sheet 4 positioned closer to the folding side than the peripheries of the cutout portions (a region within a distance from the folding side in FIG. 2A equal to or less than a distance “d”), a region where the reflection sheet 4 is adhered to the mold 1 is not formed. In this case, the reflection sheet 4 is not adhered to the mold 1 in the region within the distance from the folding side equal to or less than “d”. However, the reflection sheet 4 is covered with the FPC 11 to compensate for such a constitution and hence, there arises no problems particularly. Accordingly, the present invention is applicable to the liquid crystal display module even when the space to which the reflection sheet 4 is adhered is not sufficiently ensured (for example, when the mold 1 has a small frame width as shown in FIG. 7 and FIG. 9). It is needless to say that the present invention is applicable to the mold 1 having the large frame width as explained in conjunction with FIG. 3 and FIG. 8.

Such an idea is also applicable when the reflection sheet 4 does not have the cutout portions. To generalize this idea, the liquid crystal display module may be configured such that in the region along the long side of the reflection sheet 4, the region which is arranged within the distance from the folding side larger than the distance “d” includes a region where the reflection sheet 4 is adhered to the mold 1, while in the region along the long side of the reflection sheet 4, the region which is arranged within the distance from the folding side smaller than the distance “d” does not have a region where the reflection sheet 4 is adhered to the mold 1 and the reflection sheet 4 is covered with the FPC 11. Due to such constitution, the present invention is applicable to the liquid crystal display module even when the space to which the reflection sheet 4 is adhered is not sufficiently ensured (for example, when the mold 1 has the small frame width as shown in FIG. 7 and FIG. 9). Here, instead of the constitution which eliminates the pressure sensitive adhesive double coated tapes 9 in the regions within the distance from the folding side smaller than the distance “d”, it may be possible to adopt the constitution in which the pressure sensitive adhesive double coated tapes 9 having a width smaller than a width of the pressure sensitive adhesive double coated tapes 9 used in the regions within the distance from the folding side larger than the distance “d” may be used in the region having the distance from the folding side smaller than the distance “d”.

As has been explained heretofore, the structure for adhering the FPC 11 to the mold 1 is not limited to the structure having the first to third portions (A, B, C) shown in FIG. 3. That is, the structure for adhering the FPC 11 is also applicable to the structures shown in FIG. 7, FIG. 8 and FIG. 9. However, by taking the reduction of the thickness, the miniaturization of the liquid crystal display device and the countermeasure against the spring-back force of the FPC 11 into consideration, it is further preferable to apply the structure for adhering the FPC 11 to the structure having the first to third portions (A, B, C) shown in FIG. 3.

In this embodiment, the explanation has been made with respect to the constitution including the semiconductor chips 12, 13 which constitute the drive circuit. However, the present invention is not limited to such a constitution. For example, the drive circuit may be constituted of one chip, the semiconductor chips 12, 13 may be mounted on the FPC 11, or the drive circuit may be constituted of thin film transistors instead of semiconductor chips and may be incorporated in the TFT substrate of the liquid crystal display module.

Although the invention made by the present inventors has been explained specifically in conjunction with the above-mentioned embodiments heretofore, it is needless to say that the present invention is not limited to the above-mentioned embodiments and various modifications can be made without departing from the scope of the present invention.

What is claimed is:

1. A liquid crystal display device comprising:
a liquid crystal display panel;
a backlight which is arranged on a back side of the liquid crystal display panel; and
a flexible printed wiring board which has one end thereof connected to a terminal portion of the liquid crystal display panel, wherein
the backlight includes a frame-like mold and a reflection sheet,
the reflection sheet is adhered to a back side of the frame-like mold,
the flexible printed wiring board is folded and has a portion thereof arranged on back sides of the frame-like mold and the reflection sheet, and
the flexible printed wiring board is adhered to the back side surface of the frame-like mold at a position where the flexible printed wiring board is not overlapped to the reflection sheet as viewed in a plan view.

2. A liquid crystal display device according to claim 1, wherein the flexible printed wiring board is adhered to the surface of the back side of the frame-like mold using a pressure sensitive adhesive double coated tape.

3. A liquid crystal display device according to claim 1, wherein the flexible printed wiring board is adhered to the frame-like mold in a region outside the reflection sheet as viewed in a plan view.

4. A liquid crystal display device according to claim 1, wherein the reflection sheet has a cutout portion which exposes the surface of the back side of the mold in a portion of a region thereof which is covered with the flexible printed wiring board, and the flexible printed wiring board is adhered to the frame-like mold in the cutout portion.

5. A liquid crystal display device according to claim 4, wherein in the liquid crystal display device, assuming a side of the flexible printed wiring board which is folded to the back side of the frame-like mold and the reflection sheet as a folding side, in a periphery of the cutout portion and a region which is arranged closer to the folding side than the cutout portion, a region where the reflection sheet is adhered to the frame-like mold is not formed, and the reflection sheet is covered with the flexible printed wiring board.

6. A liquid crystal display device according to claim 1, wherein in the liquid crystal display device, assuming a side of the flexible printed wiring board which is folded to the back side of the frame-like mold and the reflection sheet as a folding side,
in a region along a long side of the reflection sheet which is within a distance from the folding side larger than a distance “d”, a region where the reflection sheet is adhered to the frame-like mold is formed, and
in a region along the long side of the reflection sheet which is within the distance from the folding side smaller than the distance “d”, the region where the reflection sheet is adhered to the frame-like mold is not formed, and the reflection sheet is covered with the flexible printed wiring board.

7. A liquid crystal display device according to claim 1, wherein a region where the flexible printed wiring board is adhered to the surface of the back side of the frame-like mold has a shape in which a size in the direction perpendicular to the side along which the flexible printed wiring board is folded to the back side of the frame-like mold and the reflection sheet is longer than a size in the direction parallel to the side along which the flexible printed wiring board is folded to the back side of the frame-like mold and the reflection sheet.

8. A liquid crystal display device according to claim 1, wherein the frame-like mold includes a projecting portion on the back side thereof, and
the flexible printed wiring board has a through hole into which the projecting portion is inserted at a portion thereof corresponding to the projecting portion.

9. A liquid crystal display device according to claim 1, wherein the backlight includes at least one optical sheet which is arranged in the inside of the frame-like mold and a light guide plate which is arranged in the inside of the frame-like mold,
at least one side of the frame-like mold includes first to third portions where a distance between one side and an opposing side is changed in a stepped manner,
the distance between one side and the opposing side in the second portion is narrower than the distance between one side and the opposing side in the first portion,
the distance between one side and the opposing side in the third portion is narrower than the distance between one side and the opposing side in the second portion,
one substrate of the liquid crystal display panel is fixed to a first stepped portion which is formed by the first portion and the second portion,
at least one optical sheet is supported on a second stepped portion which is formed by the second portion and the third portion, and
the light guide plate is arranged inside the third portion.

10. A liquid crystal display device according to claim 9, wherein the at least one optical sheet supported on the second stepped portion is constituted of two or more optical sheets.

11. A liquid crystal display device according to claim 9, wherein the liquid crystal display panel includes at least one optical sheet which is arranged inside the third portion.

12. A liquid crystal display device according to claim 9, wherein the optical sheet is not arranged inside the third portion.

13. A liquid crystal display device according to claim 9, wherein a frame width of the frame-like mold is changed in a stepped manner in the first to third portions,
the frame width of the frame-like mold is larger in the second portion than in the first portion, and
the frame width of the frame-like mold is larger in the third portion than in the second portion.

14. A liquid crystal display device according to claim 9, wherein a side of the frame-like mold on which the first to third portions are formed is a long side of the frame-like mold.

15. A liquid crystal display device according to claim 9, wherein one substrate of the liquid crystal display panel has a polarizer which faces the at least one optical sheet, and
the polarizer has an end portion thereof overlapped to the second stepped portion as viewed in a plan view.

16. A liquid crystal display device comprising:
a backlight;
a liquid crystal display panel which is arranged over the backlight; and
a flexible printed wiring board has one end thereof connected to a terminal portion of the liquid crystal display panel, wherein
the flexible printed wiring board includes an electronic part whose setting is adjustable and a through hole,
the flexible printed wiring board is folded and has a portion thereof arranged on a back side of the backlight, and
the electronic part whose setting is adjustable is arranged at a position deeper than the through hole and at a position where the electronic part is overlapped to the through hole in a state that the liquid crystal display device is viewed from a liquid crystal display panel side.

17. A liquid crystal display device according to claim 16, wherein the backlight includes a frame-like mold, and
the electronic part whose setting is adjustable is arranged inside a profile of the frame-like mold as viewed in a plan view.

18. A liquid crystal display device according to claim 16, wherein the electronic part whose setting is adjustable is a semi-fixed resistance element or a variable resistance element.

19. A liquid crystal display device according to claim 16, wherein the electronic part whose setting is adjustable is an electronic part which adjusts a counter electrode voltage of the liquid crystal display panel.
